(19) United States
(12) Patent Application Publication
(10) Pub. No.: US 2014/0189425 A1
(43) Pub. Date: Jul. 3, 2014

(54) LIBRARY CONTROLLER AND METHOD FOR CONTROLLING LIBRARY DEVICE

(71) Applicant: FUJITSU LIMITED, Kawasaki-shi (JP)

(72) Inventor: Yoshiaki Ochi, Kawasaki (JP)

(73) Assignee: FUJITSU LIMITED, Kawasaki-shi (JP)

(21) Appl. No.: 14/043,187

(22) Filed: Oct. 1, 2013

(30) Foreign Application Priority Data
Dec. 28, 2012 (JP) 2012-287761

(51) Int. Cl. G06F 11/20

(52) U.S. Cl. CPC G06F 11/2094
USPC 714/6.32

(57) ABSTRACT

A library controller includes a data storage and a processor. The processor is configured to receive a plurality of data from a host device and write the received plurality of data to a first data buffer included in a first drive. The processor is configured to instruct, upon occurrence of a first write error, an operating unit to demount a recording medium from the first drive and mount the recording medium into a second drive. The processor is configured to receive unwritten data including the partial data from the first drive to store the received unwritten data in the data storage. The unwritten data is data stored in the first data buffer and not yet written to the recording medium. The processor is configured to read the unwritten data stored in the data storage to write the read unwritten data to a second data buffer included in the second drive.

### CROSS-REFERENCE TO RELATED APPLICATION

This application is based upon and claims the benefit of priority from the prior Japanese Patent Application No. 2012-287761 filed on Dec. 28, 2012, the entire contents of which are incorporated herein by reference.

### FIELD

The embodiment discussed herein is related to a library controller and a method for controlling a library device.

### BACKGROUND

A library device may be used in order to backup data stored on a medium such as a hard disk drive of a storage device. The library device writes data received from a host device onto a recording medium such as magnetic tape, according to write commands received from the host device.

FIG. 1 illustrates an exemplary configuration of a library device. The library device 102 in FIG. 1 includes a controller 121, drives 122-1 to 122-4, an operating unit 123, and storage 124.

The storage 124 is a storage shelf that stores multiple magnetic tapes. The drives 122-1 to 122-4 are tape drives that write data to magnetic tape and read data from magnetic tape. The drives 122-1 to 122-4 respectively include data buffers 133-1 to 133-4 for temporarily storing data.

In the following description, the terms “drive 122” and “drives 122” will be used in some cases to refer to one or more of any of the drives 122-1 to 122-4.

The operating unit 123 is a transport mechanism such as a robot, performing operations to retrieve and mount a magnetic tape from the storage 124 into a drive 122, and operations to demount and store a magnetic tape from a drive 122 in the storage 124.

The controller 121 is connected to a host device 101 by a communication line 131, and connected to the drives 122-1 to 122-4 by communication lines 132-1 to 132-4, respectively. The communication line 131 is a serial optical channel link using optical fiber, for example, while the communication lines 132-1 to 132-4 are parallel or serial Small Computer System Interface (SCSI) lines, for example.

The controller 121 communicates with the host device 101 via the communication line 131, and communicates with the drives 122-1 to 122-4 via the communication lines 132-1 to 132-4, respectively.

FIG. 2 illustrates an example of a write process by the library device 102 in FIG. 1. The host device 101 transmits a write command WR1, including data D1, to the controller 121 (S211). The controller 121 writes the data D1 to the data buffer 133-1 of the drive 122-1 by converting the write command WR1 into a command for the drive, and transferring the converted command to the drive 122-1 (S212). The drive 122-1 transmits to the controller 121 a response indicating that writing to the data buffer 133-1 has finished (S213).

In order to more quickly respond to the host device 101, the controller 121, upon receiving the response from the drive 122-1, transmits to the host device 101 a response indicating that writing to the magnetic tape 201 has finished (S214). After that, the drive 122-1 asynchronously writes the data D1 from the data buffer 133-1 to the magnetic tape 201 (S215). At this point, the drive 122-1 writes the data D1 at a beginning of tape (BOT) position within a range from the BOT to an end of tape (EOT) of the magnetic tape 201.

With an asynchronous write, a response indicating that writing has finished is transmitted from the controller 121 to the host device 101 when the writing to the data buffer 133-1 is completed. In contrast, with a synchronous write, a response indicating that writing has finished is transmitted from the controller 121 to the host device 101 when the writing to the magnetic tape 201 is completed.

Next, an example of a write process will be described with reference to FIGS. 3 to 9, for a case in which the controller 121 receives backup write commands WR1 to WR4 from the host device 101.

First, upon receiving the write command WR1 (S301 in FIG. 3), the controller 121 writes the data D1 included in the write command WR1 to the data buffer 133-1 by transferring the write command WR1 to the drive 122-1 (S302). The drive 122-1 transmits to the controller 121 a response indicating that the writing of the data D1 has finished (S303), and the controller 121 transmits to the host device 101 a response indicating that the writing of the data D1 has finished (S304).

Next, upon receiving the write command WR2 (S305), the controller 121 writes the data D2 included in the write command WR2 to the data buffer 133-1 by transferring the write command WR2 to the drive 122-1 (S306). The drive 122-1 transmits to the controller 121 a response indicating that the writing of the data D2 has finished (S307), and the controller 121 transmits to the host device 101 a response indicating that the writing of the data D2 has finished (S308).

Next, upon receiving the write command WR3 (S309), the controller 121 writes the data D3 included in the write command WR3 to the data buffer 133-1 by transferring the write command WR3 to the drive 122-1 (S310). The drive 122-1 transmits to the controller 121 a response indicating that the writing of the data D3 has finished (S311), and the controller 121 transmits to the host device 101 a response indicating that the writing of the data D3 has finished (S312).

Next, upon receiving the write command WR4 (S401 in FIG. 4), the controller 121 writes the data D4 included in the write command WR4 to the data buffer 133-1 by transferring the write command WR4 to the drive 122-1 (S402). The drive 122-1 transmits to the controller 121 a response indicating that the writing of the data D4 has finished (S403), and the controller 121 transmits to the host device 101 a response indicating that the writing of the data D4 has finished (S404).

At this point, the data buffer 133-1 has become full, and consequently the drive 122-1 writes the leading data D1 stored in the data buffer 133-1 to the magnetic tape 201, and deletes the data D1 from the data buffer 133-1 (S405).

While writing the data D1 to the magnetic tape 201, if the controller 121 receives from the host device 101 a command WFM to write a tape mark indicating a file marker (S511 in FIG. 5), the controller 121 transfers the command WFM to the drive 122-1 (S512). The drive 122-1 defers execution of the command WFM until all data stored in the data buffer 133-1 is written to the magnetic tape 201.

If the writing of the data D1 finishes normally (S501), the drive 122-1 writes the data D2 stored in the data buffer 133-1 to the magnetic tape 201, and deletes the data D2 from the data buffer 133-1 (S601 in FIG. 6).

If the writing of the data D2 finishes normally (S602), the drive 122-1 writes the data D3 stored in the data buffer 133-1 to the magnetic tape 201, and deletes the data D3 from the data buffer 133-1 (S701 in FIG. 7).

If the writing of the data D3 finishes normally (S702), the drive 122-1 writes the data D4 stored in the data buffer 133-1 to the magnetic tape 201, and deletes the data D4 from the data buffer 133-1 (S801 in FIG. 8).

If the writing of the data D4 finishes normally (S802), all of the data D1 to D4 stored in the data buffer 133-1 has been written to the magnetic tape 201, and the data buffer 133-1 becomes empty. Consequently, the drive 122-1 executes the deferred command WFM, and writes a tape mark 911 at a position after the data D4 on the magnetic tape 201 (S901 in FIG. 9).

If the writing of the tape mark 911 finishes normally (S902), the drive 122-1 transmits to the controller 121 a response indicating that the writing of the tape mark 911 has finished (S903). The controller 121 transmits to the host device 101 a response indicating that the writing of the tape mark 911 has finished (S904).

There also exists a magnetic tape control device including a main buffer that temporarily buffers write data transferred in units of blocks via an input/output bus, and an auxiliary buffer that receives and stores the write data temporarily buffered in the main buffer. When retrying the writing due to a write error in a magnetic tape device, the magnetic tape control device transfers write data stored in the auxiliary buffer to a cache buffer of the magnetic tape device, and causes the data to be written.

A related technique is disclosed in, for example, Japanese Laid-open Patent Publication No. 6-175792.

The library device of the related art described above has problems like the following.

In the case where writing to magnetic tape fails due to a malfunction of the magnetic tape or a malfunction of a magnetic head in a drive, a dynamic device reconfiguration (DDR) process may be conducted. With a DDR process, the library device mounts the magnetic tape having a write failure into another drive, and continues writing data from the position where the writing failed in order to recover data.

However, with a DDR process, the write data that has been transferred from the host device to a drive is transferred back to the host device as unwritten data, and once again transferred from the host device to another drive. For this reason, the transfer of unwritten data is time-consuming, while also increasing the load on the host device.

Furthermore, due to recent advances in technology, the magnetic tape format in library devices is shifting from cartridge magnetic tape (CMT) to linear tape-open (LTO), with a corresponding increase in capacity of the data buffer inside drives. As the capacity of the data buffer increases, the size of unwritten data correspondingly increases. For this reason, the transfer of unwritten data takes more time, and the load on the host device becomes greater compared to the case of CMT.

Note that these problems are not limited to the case of using magnetic tape as a recording medium, and also occur in the case of using other recording media.

### SUMMARY

According to an aspect of the present invention, provided is a library controller for controlling a library device including a first drive, a second drive, and an operating unit. The library controller includes a data storage and a processor. The processor is configured to receive a plurality of data from a host device. The processor is configured to write the received plurality of data to a first data buffer included in the first drive. The processor is configured to instruct, upon occurrence of a first write error, the operating unit to demount a recording medium from the first drive and mount the recording medium into the second drive. The first write error is an error occurred while the first drive is writing partial data from among the plurality of data stored in the first data buffer to the recording medium. The processor is configured to receive unwritten data including the partial data from the first drive to store the received unwritten data in the data storage. The unwritten data is data stored in the first data buffer and not yet written to the recording medium. The processor is configured to read the unwritten data stored in the data storage to write the read unwritten data to a second data buffer included in the second drive.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an exemplary configuration of a library device of a related art;

FIG. 2 is a diagram illustrating a first write process of a related art;

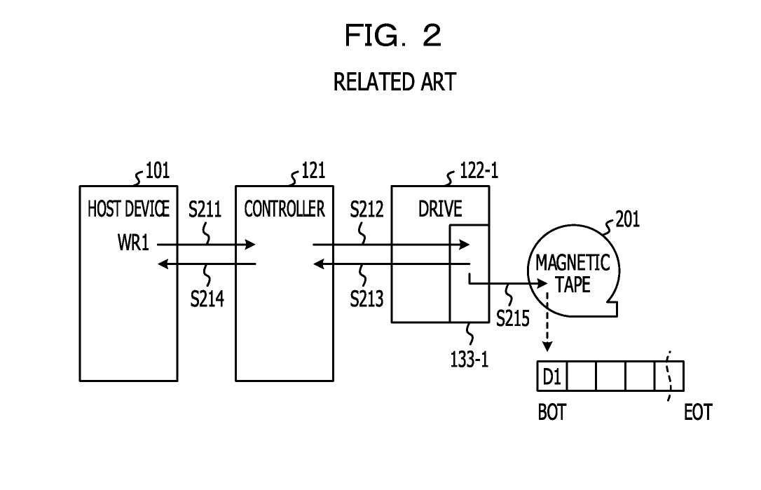

FIG. 3 is a diagram illustrating a second write process of a related art;

FIG. 4 is a diagram illustrating a second write process of a related art;

FIG. 5 is a diagram illustrating a second write process of a related art;

FIG. 6 is a diagram illustrating a second write process of a related art;

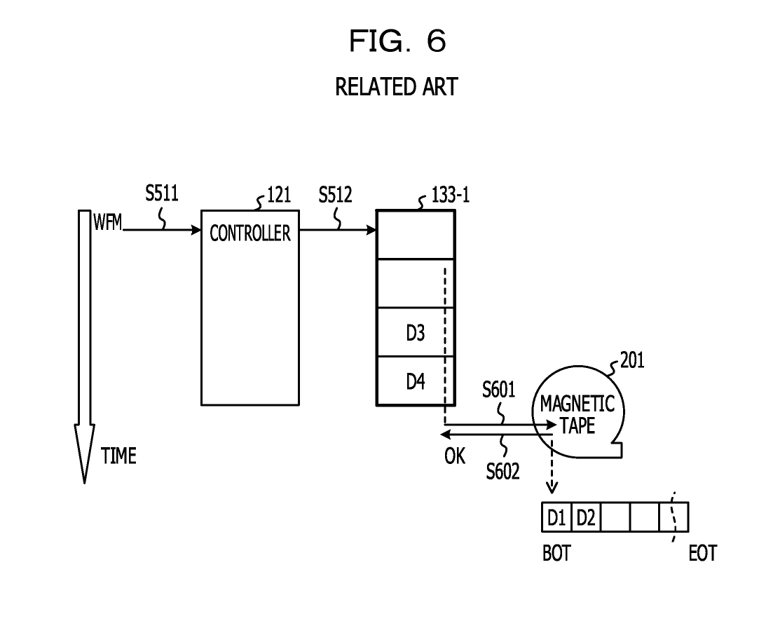

FIG. 7 is a diagram illustrating a second write process of a related art;

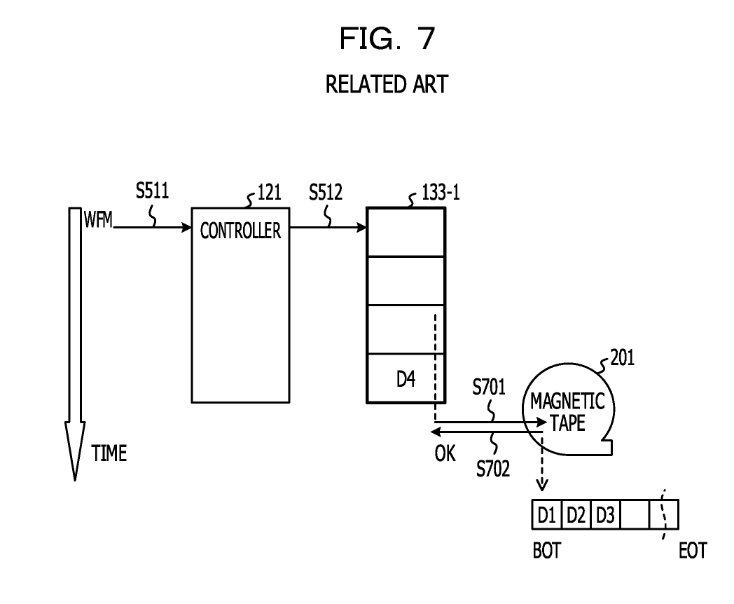

FIG. 8 is a diagram illustrating a second write process of a related art;

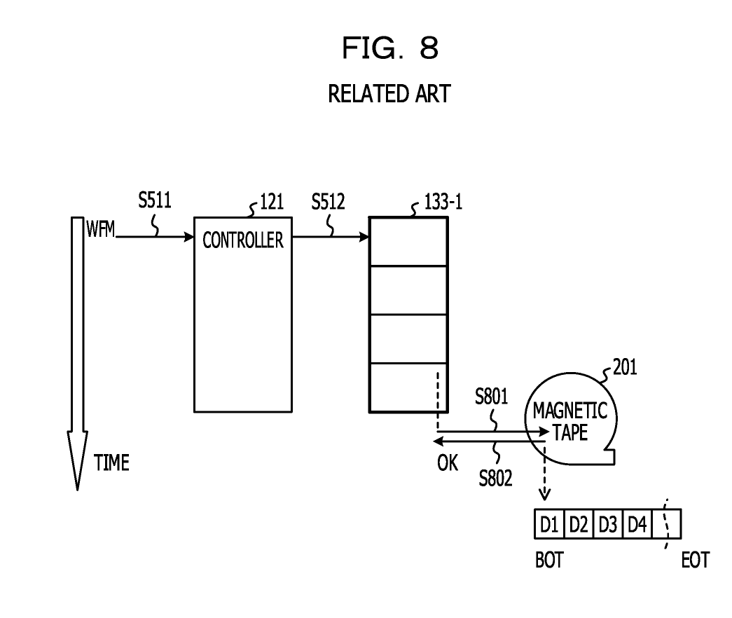

FIG. 9 is a diagram illustrating a second write process of a related art;

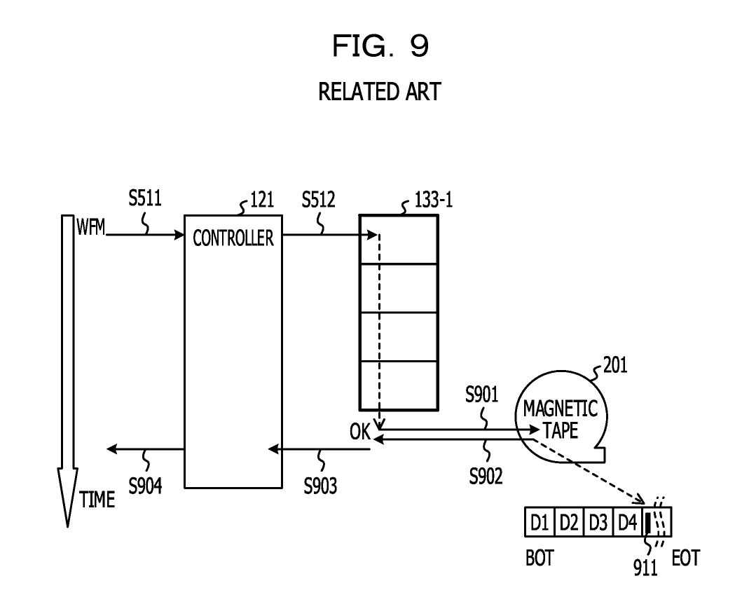

FIG. 10 is a diagram illustrating a first DDR process;

FIG. 11 is a diagram illustrating a second DDR process;

FIG. 12 is a diagram illustrating a second DDR process;

FIG. 13 is a diagram illustrating a second DDR process;

FIG. 14 is a diagram illustrating a second DDR process;

FIG. 15 is a diagram illustrating a second DDR process;

FIG. 16 is a diagram illustrating a second DDR process;

FIG. 17 is a diagram illustrating a second DDR process;

FIG. 18 is a diagram illustrating a second DDR process;

FIG. 19 is a diagram illustrating an exemplary configuration of a library device according to an embodiment;

FIG. 20 is a flowchart of write control;

FIG. 21 is a diagram illustrating an exemplary hardware configuration of a controller;

FIG. 22 is a diagram illustrating write control;

FIG. 23 is a flowchart of write control in a case where a write error occurs;

FIG. 24 is a flowchart of an interrupt process;

FIG. 25 is a flowchart of a process conducted by a host device;

FIG. 26 is a diagram illustrating a write control sequence in a case where a write error occurs; and

FIG. 27 is a diagram illustrating a write control sequence in a case where a write error occurs.

### DESCRIPTION OF EMBODIMENT

Hereinafter, an embodiment will be described in detail with reference to the drawings.

As discussed above, with a library device of a related art, it is possible to respond more quickly to a host device by asynchronously writing data from a controller to a drive's data buffer, and from the data buffer to magnetic tape. Thus, the host device becomes able to conduct another process without waiting for the writing to magnetic tape to finish. However, as discussed above, the library device of the related art has problems related to a DDR process.

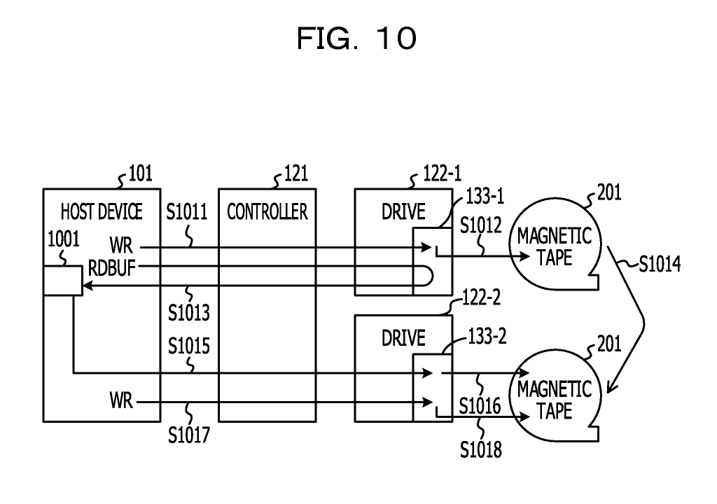

First, a DDR process will be described with reference to FIG. 10.

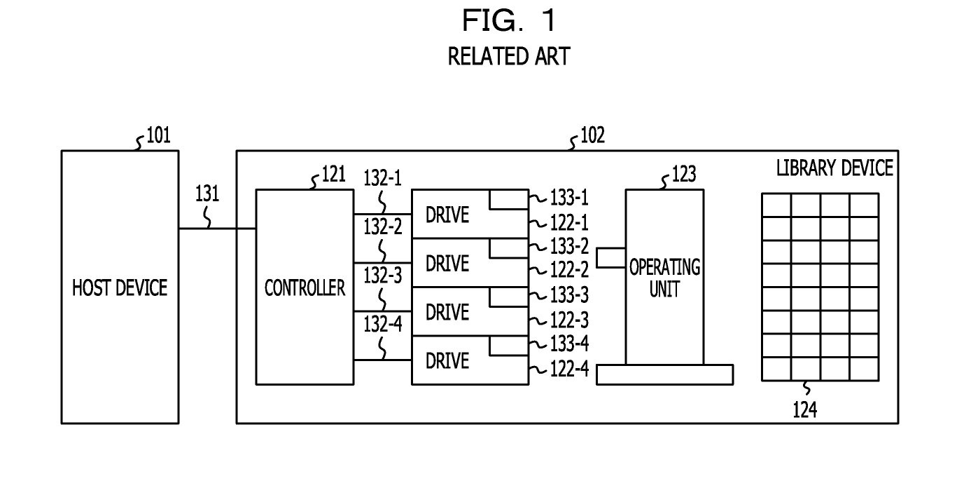

FIG. 10 illustrates an example of a DDR process by the library device 102 in FIG. 1. As part of a backup process, the host device 101 transmits to the controller 121 a write command WR for the drive 122-1 (S1011). The controller 121 converts the write command WR into a command for the drive, and transfers the converted command to the drive 122-1. After that, a write error occurs during the asynchronous writing from the data buffer 133-1 of the drive 122-1 to the magnetic tape 201 (S1012).

At this point, the host device 101 transmits to the controller 121 a command RDBUF for reading data (unwritten data) not yet written to the magnetic tape 201 from the data buffer 133-1 of the drive 122-1 (S1013). The controller 121 converts the command RDBUF into a command for the drive, and transfers the converted command to the drive 122-1. The drive 122-1 then transmits unwritten data stored in the data buffer 133-1 to the host device 101 via the controller 121. The host device 101 stores the received unwritten data in DDR memory 1001.

Next, the host device 101 controls the operating unit 123 via the controller 121 to demount the magnetic tape 201 from the drive 122-1, and to mount the magnetic tape 201 in another free drive 122-2 (S1014). The host device 101 then positions, via the controller 121, the write position of the drive 122-2 to the position at which writing to the magnetic tape 201 has been failed.

Next, the host device 101 transfers the unwritten data from the DDR memory 1001 to the drive 122-2 via the controller 121, and writes the unwritten data to the data buffer 133-2 of the drive 122-2 (S1015). The drive 122-2 writes unwritten data to the magnetic tape 201 by synchronous writing (S1016).

Next, the host device 101 transmits to the controller 121 a write command WR for the drive 122-2 (S1017). The controller 121 writes the data included in the write command WR to the data buffer 133-2 of the drive 122-2 by converting the write command WR into a command for the drive, and transferring the converted command to the drive 122-2. The drive 122-2 then asynchronously writes data stored in the data buffer 133-2 to the magnetic tape 201 (S1018). Thus, the remaining data is written to the magnetic tape 201 via the drive 122-2, and the backup process finishes.

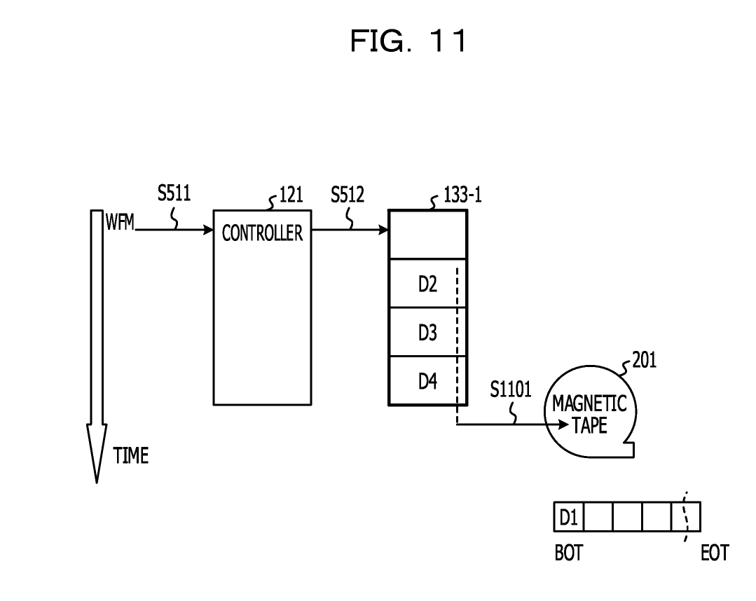

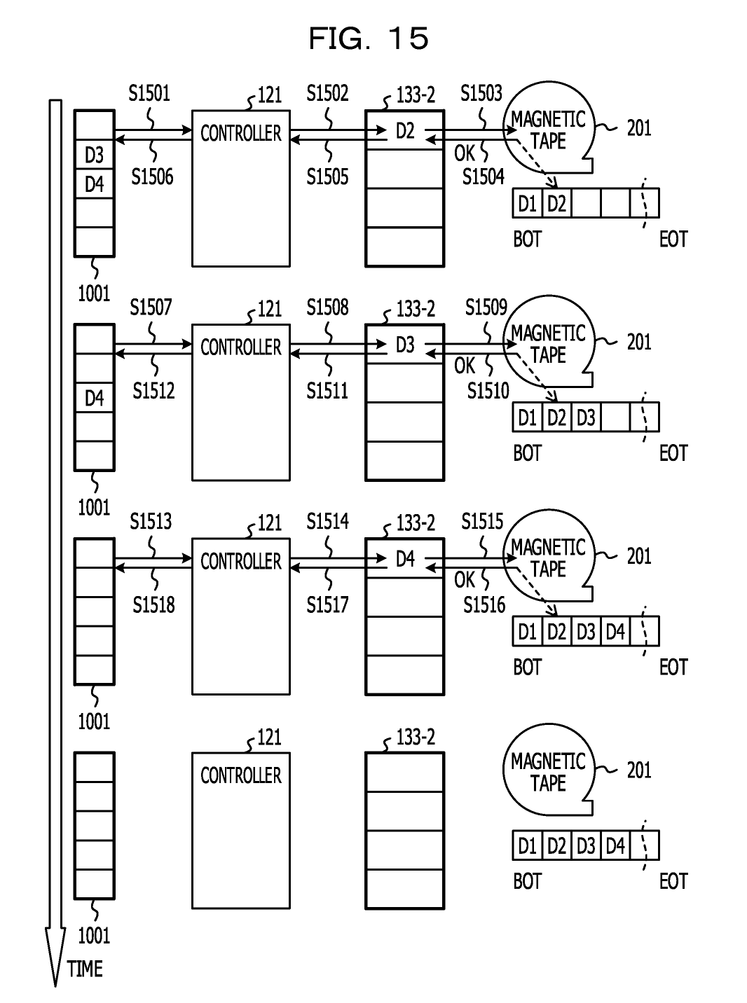

Next, an example of a DDR process will be described with reference to FIGS. 11 to 18, for a case in which the controller 121 receives write commands WR1 to WR8 from the host device 101.

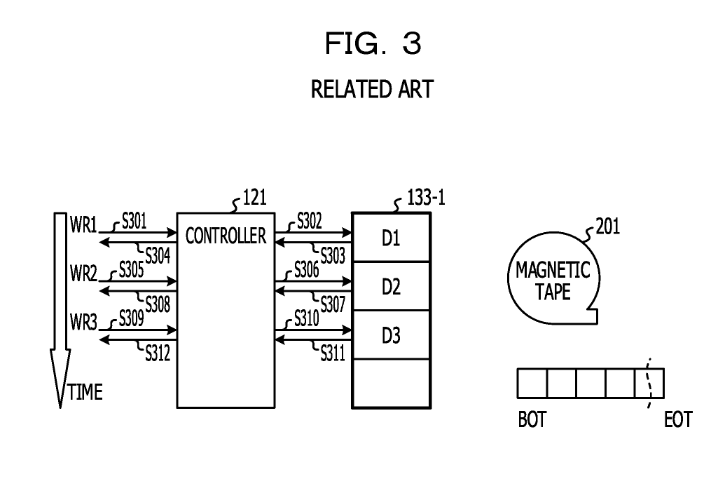

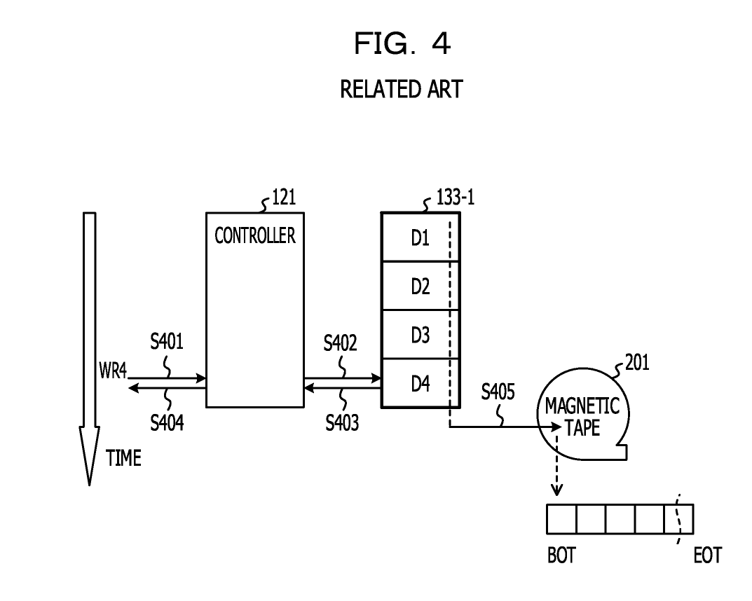

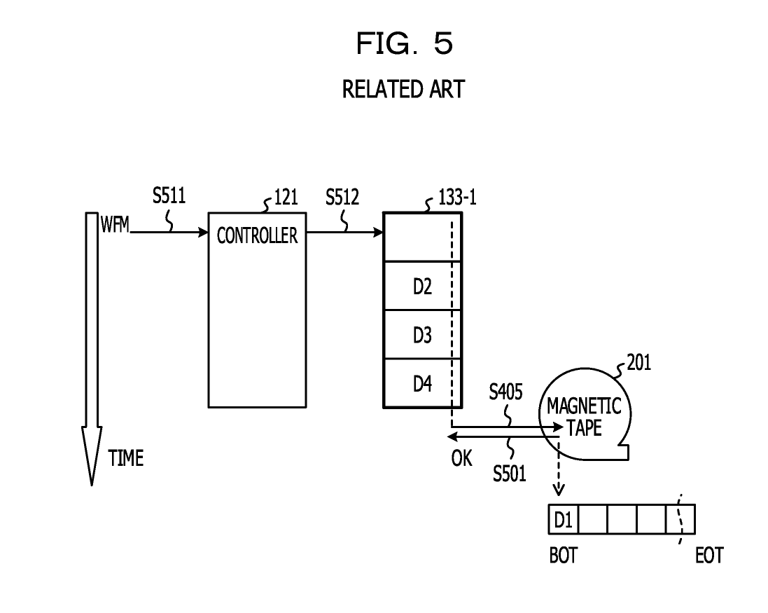

The procedure by which the controller 121 receives write commands WR1 to WR4 and writes data D1 to D4 to the data buffer 133-1, and the drive 122-1 writes the data D1 to the magnetic tape 201, is similar to the procedure illustrated in FIGS. 3 to 5.

If the writing of the data D1 finishes normally (S501), the drive 122-1 writes the data D2 stored in the data buffer 133-1 to the magnetic tape 201 (S1101 in FIG. 11).

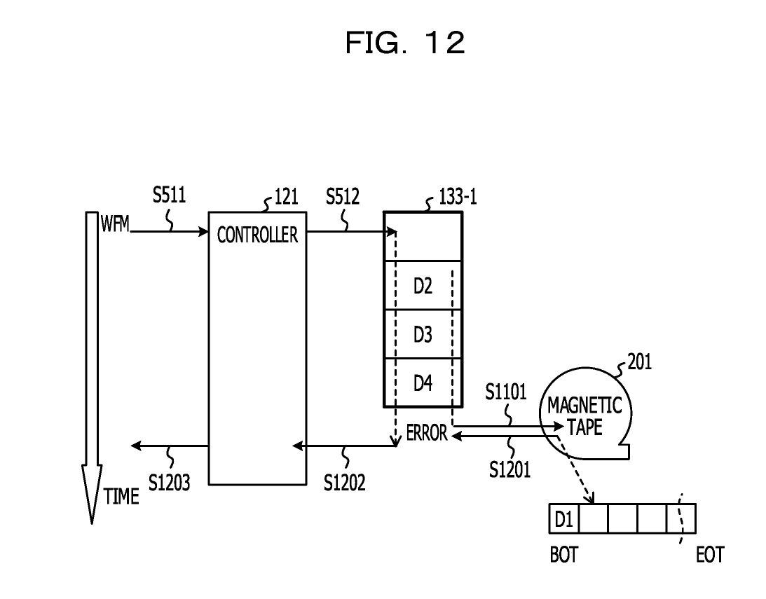

At this point, a write error occurs (S1201 in FIG. 12). Thus, the drive 122-1 transmits to the controller 121 a response indicating that the writing of the data D2 has failed as a response to the command WFM (S1202). In this case, the drive 122-1 does not delete the data D2 from the data buffer 133-1. The controller 121 transmits to the host device 101 a response indicating that the writing of the data D2 has failed, along with a DDR request (S1203).

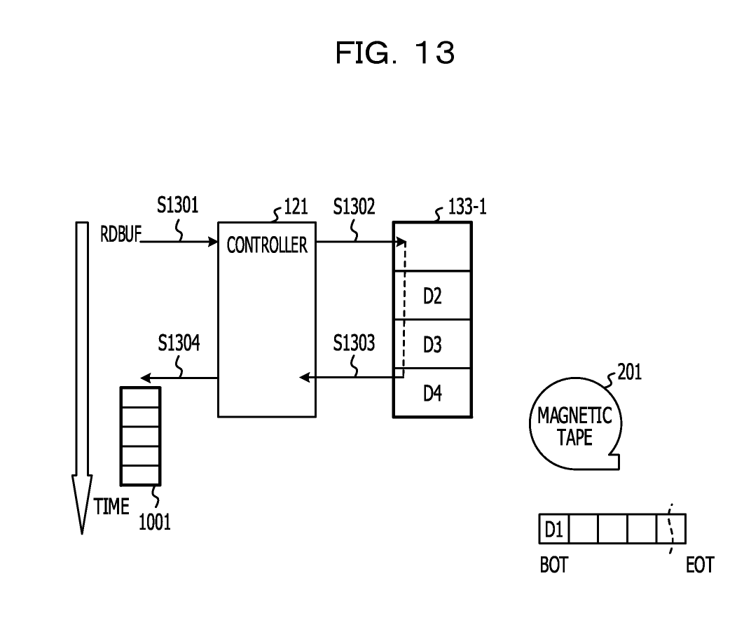

The host device 101 starts a DDR process on the basis of the received DDR request, and transmits a command RDBUF to the controller 121 (S1301 in FIG. 13). The controller 121 converts the command RDBUF into a command for the drive, and transfers the converted command to the drive 122-1 (S1302).

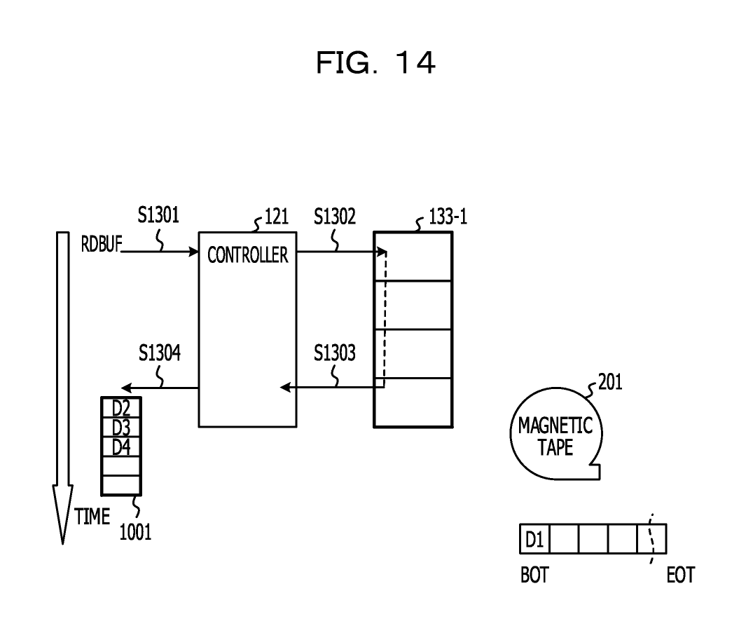

The drive 122-1 transmits unwritten data D2 to D4 stored in the data buffer 133-1 to the host device 101 via the controller 121 (S1303), and deletes the unwritten data D2 to D4 from the data buffer 133-1. The controller 121 transfers the unwritten data D2 to D4 to the host device 101 (S1304). The host device 101 stores the received unwritten data D2 to D4 in the DDR memory 1001 (FIG. 14).

Next, the host device 101 controls the operating unit 123 via the controller 121 to demount the magnetic tape 201 from the drive 122-1, and to mount the magnetic tape 201 in another free drive 122-2. The host device 101 then positions, via the controller 121, the write position of the drive 122-2 to the position at which writing to the magnetic tape 201 has been failed.

Next, the host device 101 transfers the unwritten data D2 to D4 from the DDR memory 1001 to the drive 122-2 via the controller 121, and writes the unwritten data D2 to D4 to the data buffer 133-2 of the drive 122-2. The drive 122-2 writes the unwritten data D2 to D4 to the magnetic tape 201 by synchronous writing.

First, the host device 101 reads the unwritten data D2 from the DDR memory 1001, and transmits a write command including the unwritten data D2 to the controller 121 (S1501). The controller 121 writes the unwritten data D2 to the data buffer 133-2 by transferring the received write command to the drive 122-2 (S1502).

The drive 122-2 writes the unwritten data D2 to the magnetic tape 201 by synchronous writing (S1503). Then, if the writing of the data D2 finishes normally (S1504), the drive 122-2 deletes the data D2 from the data buffer 133-2, and transmits to the controller 121 a response indicating that the writing of the data D2 has finished (S1505). The controller 121 transmits to the host device 101 a response indicating that the writing of the data D2 has finished (S1506).

Next, the host device 101 reads the unwritten data D3 from the DDR memory 1001, and transmits a write command including the unwritten data D3 to the controller 121 (S1507). The controller 121 writes the unwritten data D3 to the data buffer 133-2 by transferring the received write command to the drive 122-2 (S1508).

The drive 122-2 writes the unwritten data D3 to the magnetic tape 201 by synchronous writing (S1509). Then, if the writing of the data D3 finishes normally (S1510), the drive 122-2 deletes the data D3 from the data buffer 133-2, and transmits to the controller 121 a response indicating that the writing of the data D3 has finished (S1511). The controller 121 transmits to the host device 101 a response indicating that the writing of the data D3 has finished (S1512).

Next, the host device 101 reads the unwritten data D4 from the DDR memory 1001, and transmits a write command including the unwritten data D4 to the controller 121 (S1513). The controller 121 writes the unwritten data D4 to the data buffer 133-2 by transferring the received write command to the drive 122-2 (S1514).

The drive 122-2 writes the unwritten data D4 to the magnetic tape 201 by synchronous writing (S1515). Then, if the writing of the data D4 finishes normally (S1516), the drive 122-2 deletes the data D4 from the data buffer 133-2, and transmits to the controller 121 a response indicating that the writing of the data D4 has finished (S1517). The controller 121 transmits to the host device 101 a response indicating that the writing of the data D4 has finished (S1518).

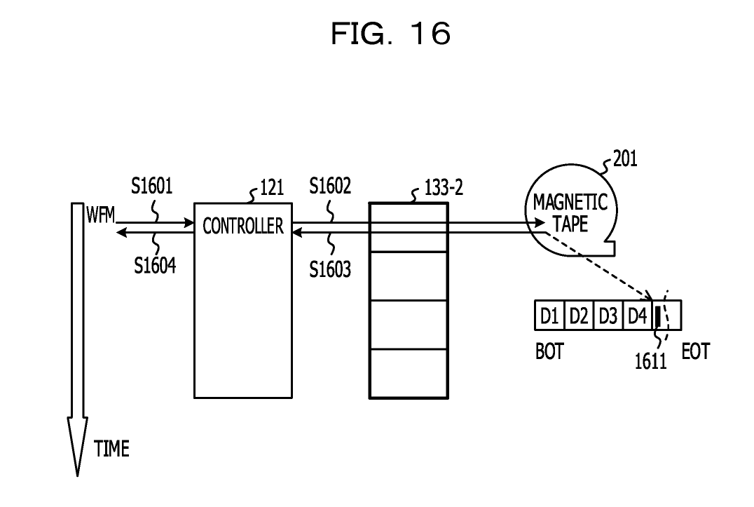

Next, if the controller 121 receives a command WFM from the host device 101 (S1601 in FIG. 16), the controller 121 transfers the command WFM to the drive 122-1 (S1602). The drive 122-1 executes the command WFM, and writes a tape mark 1611 at a position after the data D4 on the magnetic tape 201.

If the writing of the tape mark 1611 finishes normally, the drive 122-1 transmits to the controller 121 a response indicating that the writing of the tape mark 1611 has finished (S1603). The controller 121 transmits to the host device 101 a response indicating that the writing of the tape mark 1611 has finished (S1604).

Next, the host device 101 transmits the remaining write commands WR5 to WR8 to the controller 121.

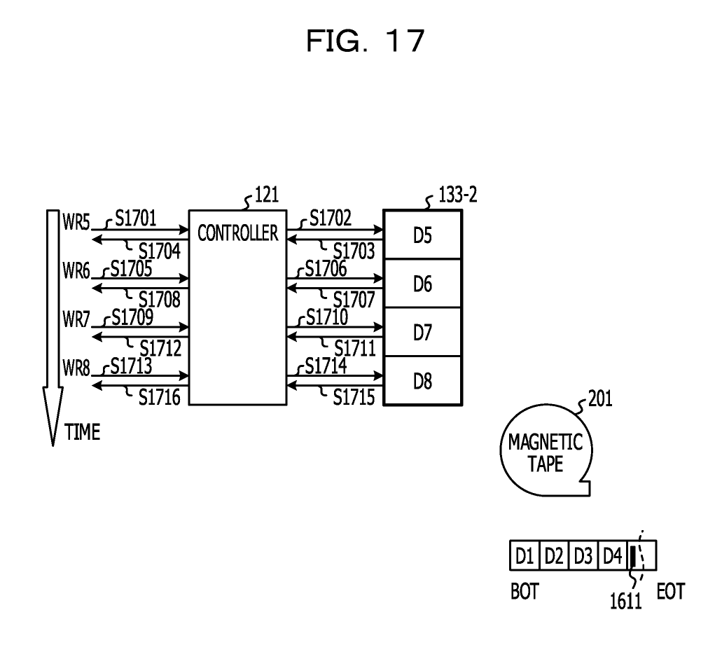

First, upon receiving the write command WR5 (S1701 in FIG. 17), the controller 121 writes the data D5 included in the write command WR5 to the data buffer 133-2 by transferring the write command WR5 to the drive 122-2 (S1702). The drive 122-2 transmits to the controller 121 a response indicating that the writing of the data D5 has finished (S1703). The controller 121 transmits to the host device 101 a response indicating that the writing of the data D5 has finished (S1704).

Next, upon receiving the write command WR6 (S1705), the controller 121 writes the data D6 included in the write command WR6 to the data buffer 133-2 by transferring the write command WR6 to the drive 122-2 (S1706). The drive 122-2 transmits to the controller 121 a response indicating that the writing of the data D6 has finished (S1707). The controller 121 transmits to the host device 101 a response indicating that the writing of the data D6 has finished (S1708).

Next, upon receiving the write command WR7 (S1709), the controller 121 writes the data D7 included in the write command WR7 to the data buffer 133-2 by transferring the write command WR7 to the drive 122-2 (S1710). The drive 122-2 transmits to the controller 121 a response indicating that the writing of the data D7 has finished (S1711). The controller 121 transmits to the host device 101 a response indicating that the writing of the data D7 has finished (S1712).

Next, upon receiving the write command WR8 (S1713), the controller 121 writes the data D8 included in the write command WR8 to the data buffer 133-2 by transferring the write command WR8 to the drive 122-2 (S1714). The drive 122-2 transmits to the controller 121 a response indicating that the writing of the data D8 has finished (S1715), and the controller 121 transmits to the host device 101 a response indicating that the writing of the data D8 has finished (S1716).

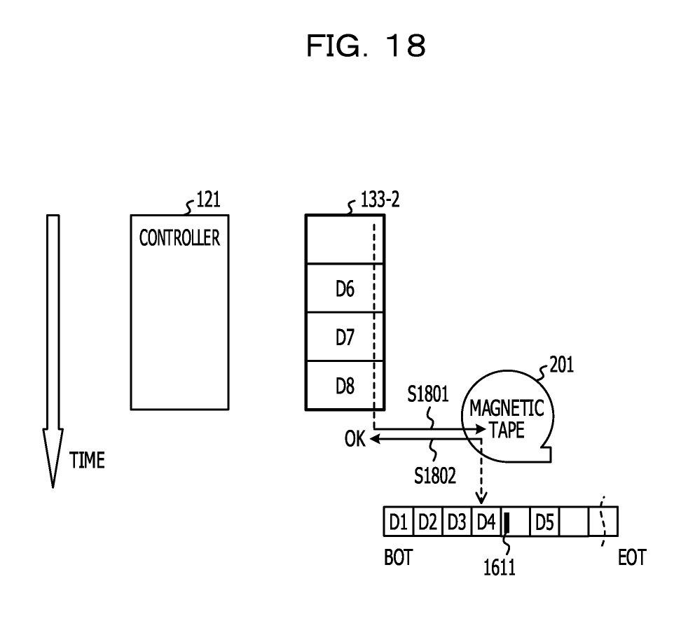

At this point, the data buffer 133-2 has become full, and consequently the drive 122-2 writes the leading data D5 stored in the data buffer 133-2 at a position after the tape mark 1611 on the magnetic tape 201 (S1801 in FIG. 18). The drive 122-2 then deletes the data D5 from the data buffer 133-2.

If the writing of the data D5 finishes normally (S1802), the drive 122-2 sequentially writes the data D6 to D8 to the magnetic tape 201, similarly to S1801. Thus, the remaining data D5 to D8 is written to the magnetic tape 201, and the backup process finishes.

According to such a DDR process, even in the case where a write error occurs during a backup process, it is still possible to remount the magnetic tape into another drive and continue the backup process, if the magnetic tape is not malfunctioning.

However, the transfer of unwritten data in a DDR process is time-consuming, while also increasing the load on the host device, as described above.

Furthermore, the transfer of unwritten data in the case of LTO takes more time, and the load on the host device becomes greater compared to the case of CMT, as described above.

The inventor realized that if the controller of the library device were to read and transfer the unwritten data from the drive in which a write error occurred to another drive, it would be possible to continue the backup process without transferring the unwritten data to the host device. Not transferring the unwritten data to the host device shortens the time taken to transfer the unwritten data, while also reducing the load on the host device.

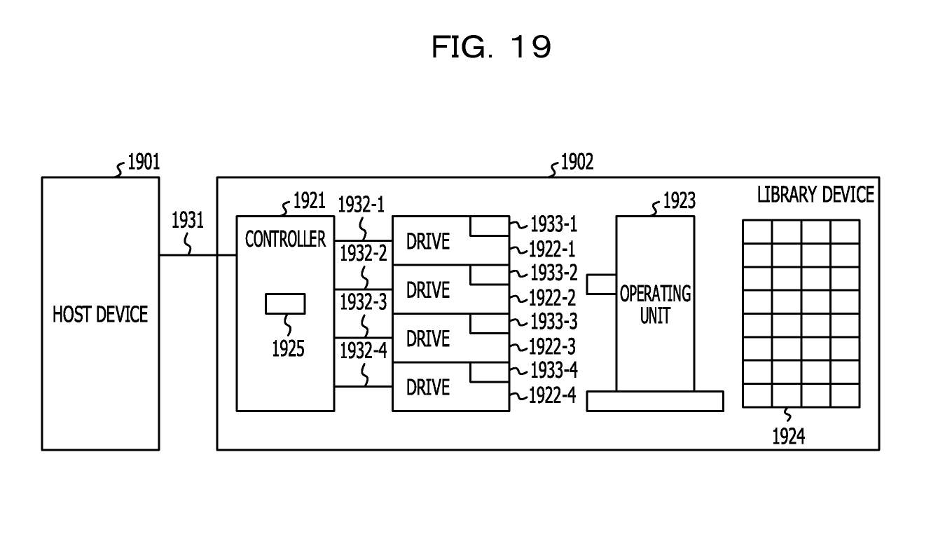

FIG. 19 illustrates an exemplary configuration of a library device according to an embodiment. The library device 1902 in FIG. 19 includes a controller 1921, drives 1922-1 to 1922-4, an operating unit 1923, and storage 1924. The controller 1921 includes a data buffer 1925.

The storage 1924 is a storage shelf that stores one or multiple recording media. The drives 1922-1 to 1922-4 are media drives that write data to recording media and read data from recording media. Media such as magnetic tapes, optical discs, magneto-optical discs, and magnetic disks may be used as the recording media.

The drives 1922-1 to 1922-4 respectively include data buffers 1933-1 to 1933-4 for temporarily storing data. In addition, the drives 1922-1 to 1922-4 respectively write data stored in the data buffers 1933-1 to 1933-4 to recording media.

In the following description, the terms “drive 1922” and “drives 1922” will be used in some cases to refer to one or more of any of the drives 1922-1 to 1922-4. Also, the terms “data buffer 1933” and “data buffers 1933”will be used in some cases to refer to one or more of any of the data buffers 1933-1 to 1933-4.

The number of drives 1922 is not limited to 4, and may be an integer equal to or greater than 2. Also, each data buffer 1933 is assumed to become full when data included in N write commands (where N is an integer equal to or greater than 2) has been written.

The operating unit 1923 is a transport mechanism such as a robot, performing operations to retrieve and mount a recording medium from the storage 1924 into a drive 1922, and operations to demount and store a recording medium from a drive 1922 in the storage 1924.

The controller 1921 is connected to a host device 1901 by a communication line 1931, and connected to the drives 1922-1 to 1922-4 by communication lines 1932-1 to 1932-4, respectively. The communication line 1931 is a serial optical channel link using optical fiber, for example, while the communication lines 1932-1 to 1932-4 are parallel or serial SCSI lines, for example.

The controller 1921 communicates with the host device 1901 via the communication line 1931, and communicates with the drives 1922-1 to 1922-4 via the communication lines 1932-1 to 1932-4, respectively.

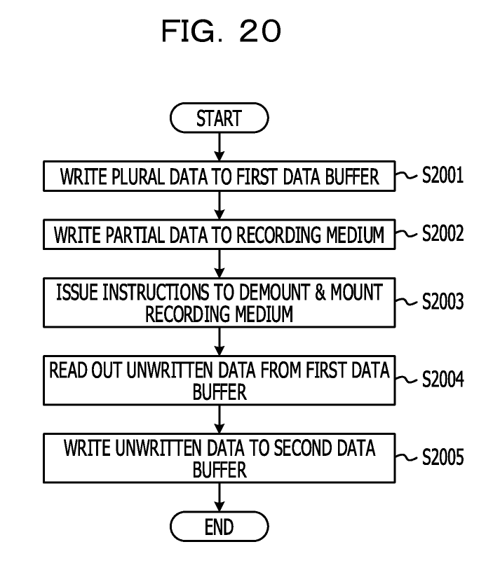

FIG. 20 is a flowchart illustrating an example of write control by the library device in FIG. 19.

First, the controller 1921 receives plural data from the host device 1901 and writes the received plural data to a first data buffer 1933 included in a first drive 1922 from among the drives 1922-1 to 1922-4 (S2001).

Next, the first drive 1922 writes part of the plural data stored in the first data buffer 1933 to a recording medium retrieved from the storage 1924 and mounted into the first drive 1922 by the operating unit 1923 (S2002).

In the case where a write error occurs while writing to the recording medium, the controller 1921 instructs the operating unit 1923 to demount the recording medium from the first drive 1922, and to mount the recording medium into a second drive 1922 (S2003). Next, the controller 1921 reads unwritten data, including the above part of the data, from the first data buffer 1933, and stores the read data in the data buffer 1925 (S2004). The controller 1921 then reads the unwritten data from the data buffer 1925, and writes the unwritten data to a second data buffer 1933 included in the second drive 1922 (S2005).

According to such write control, it is possible to shorten the time taken to transfer unwritten data in the case where writing to a recording medium fails.

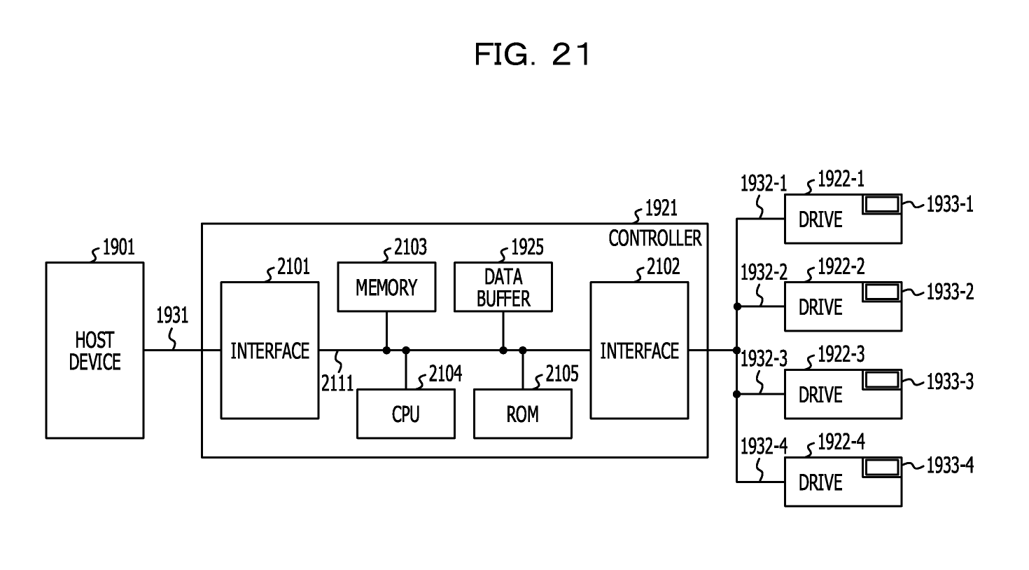

FIG. 21 illustrates an exemplary hardware configuration of the controller 1921 in FIG. 19. The controller 1921 in FIG. 21 is an information processing device (computer), and includes the data buffer 1925, an interface 2101, an interface 2102, memory 2103, a central processing unit (CPU) 2104, and read-only memory (ROM) 2105. These constituent elements are connected to each other by a bus 2111.

The data buffer 1925 is memory for storing part or all of the unwritten data. The capacity of the data buffer 1925 is not particularly limited, but is preferably the same as or greater than the capacity of the data buffer 1933.

The ROM 2105 is memory that stores programs used for control of the library device 1902. The memory 2103 is semiconductor memory such as random access memory (RAM) or flash memory. The CPU 2104 (processor) controls the library device 1902 by loading a program from the ROM 2105 into the memory 2103, and executing the program.

Control of the library device 1902 by the CPU 2104 includes the following processes.

(1) A process of converting a command received from the host device 1901 into a command for a drive, and transferring the converted command to a drive 1922.

(2) A process that, in the case where a write error occurs, instructs the operating unit 1923 to demount a recording medium from a first drive 1922, and to mount the recording medium into a second drive 1922.

(3) A process that, in the case where a write error occurs, reads unwritten data from a first data buffer 1933 and stores the unwritten data in the data buffer 1925, and reads the unwritten data from the data buffer 1925 and writes the unwritten data to a second data buffer 1933.

The interface 2101 is a communication interface that conducts data conversion as part of communication with the host device 1901 via the communication line 1931. The interface 2102 is a communication interface that conducts data conversion as part of communication with the drives 1922-1 to 1922-4 via the communication lines 1932-1 to 1932-4, respectively.

The controller 1921 may additionally include an auxiliary memory device such as a magnetic disk device, an optical disc device, a magneto-optical disc device, or a tape device. The auxiliary memory device also encompasses a hard disk drive as well as semiconductor memory such as flash memory. A program may be stored in advance in the auxiliary memory device, and the controller 1921 is able to load the program in the memory 2103 to use the program.

The controller 1921 may additionally include a media drive that drives a portable recording medium, and accesses the recorded content thereof. The portable recording medium is a medium such as a memory device, a flexible disk, an optical disc, or a magneto-optical disc. The portable recording medium also encompasses media such as a compact disc read-only memory (CD-ROM), a digital versatile disc (DVD), and universal serial bus (USB) memory. A program may be stored in advance in the portable recording medium, and a user or operator is able to load and use the program in the memory 2103.

In this way, a computer-readable recording medium storing a program used for control of the library device 1902 encompasses physical (non-transitory) recording media, such as the memory 2103, the ROM 2105, an auxiliary memory device, and a portable recording medium.

The controller 1921 may additionally include a network connection device that is connected to a communication network such as a local area network (LAN). The controller 1921 is also able to receive a program from an external device via the network connection device, and load the program in the memory 2103 to use the program.

Note that the controller 1921 is not limited to including all of the constituent elements in FIG. 21, and that it is also possible to omit some constituent elements depending on the application and conditions. For example, the ROM 2105 may be omitted in the case where the controller 1921 receives a program from a portable recording medium or an external device.

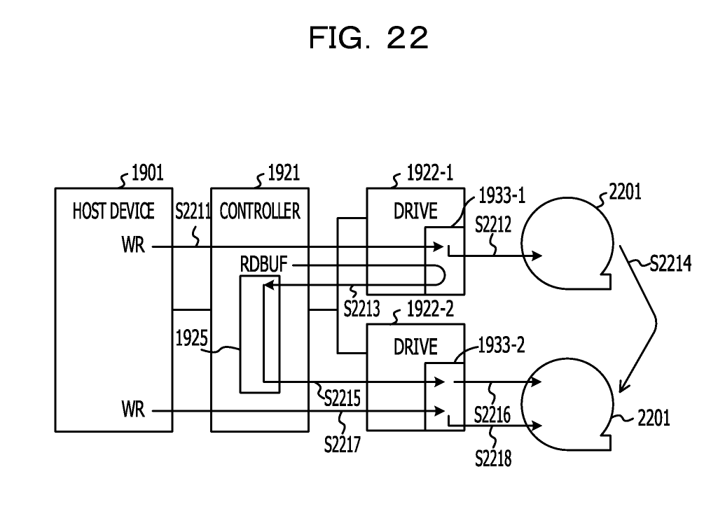

FIG. 22 illustrates an example of write control by the library device 1902 in FIG. 19. As part of a backup process, the host device 1901 transmits to the controller 1921 a write command WR for the drive 1922-1 (S2211). The controller 1921 converts the write command WR into a command for the drive, and transfers the converted command to the drive 1922-1. After that, a write error occurs during the asynchronous writing from the data buffer 1933-1 of the drive 1922-1 to the recording medium 2201 (S2212).

At this point, the controller 1921 transmits to the drive 1922-1 a command RDBUF for reading unwritten data from the data buffer 1933-1 of the drive 1922-1 (S2213). The drive 1922-1 transmits unwritten data stored in the data buffer 1933-1 to the controller 1921. The controller 1921 stores the received unwritten data in the data buffer 1925.

Next, the controller 1921 controls the operating unit 1923 to demount the recording medium 2201 from the drive 1922-1, and to mount the recording medium 2201 in another free drive 1922-2 (S2214). The controller 1921 then positions the write position of the drive 1922-2 to the position at which writing to the recording medium 2201 failed.

Next, the controller 1921 transfers unwritten data from the data buffer 1925 to the drive 1922-2, and writes the unwritten data to the data buffer 1933-2 of the drive 1922-2 (S2215). The drive 1922-2 writes unwritten data to the recording medium 2201 by synchronous writing (S2216).

Next, the host device 1901 transmits to the controller 1921 a write command WR for the drive 1922-1 (S2217). At this point, the controller 1921 converts the write command WR into a write command for the drive 1922-2, and transfers the converted command to the drive 1922-2 instead of the drive 1922-1. The drive 1922-2 then asynchronously writes data stored in the data buffer 1933-2 to the recording medium 2201 (S2218). Thus, the remaining data is written to the recording medium 2201 via the drive 1922-2, and the backup process finishes.

According to such write control, in the case where a write error occurs, it is still possible to continue a backup process without transferring unwritten data to the host device 1901. Consequently, the time taken to transfer unwritten data is shortened, and the load on the host device 1901 is reduced. Furthermore, since the host device 1901 is able to conduct another process while the controller 1921 is controlling the writing of unwritten data to the recording medium 2201, the utilization of the host device 1901 improves.

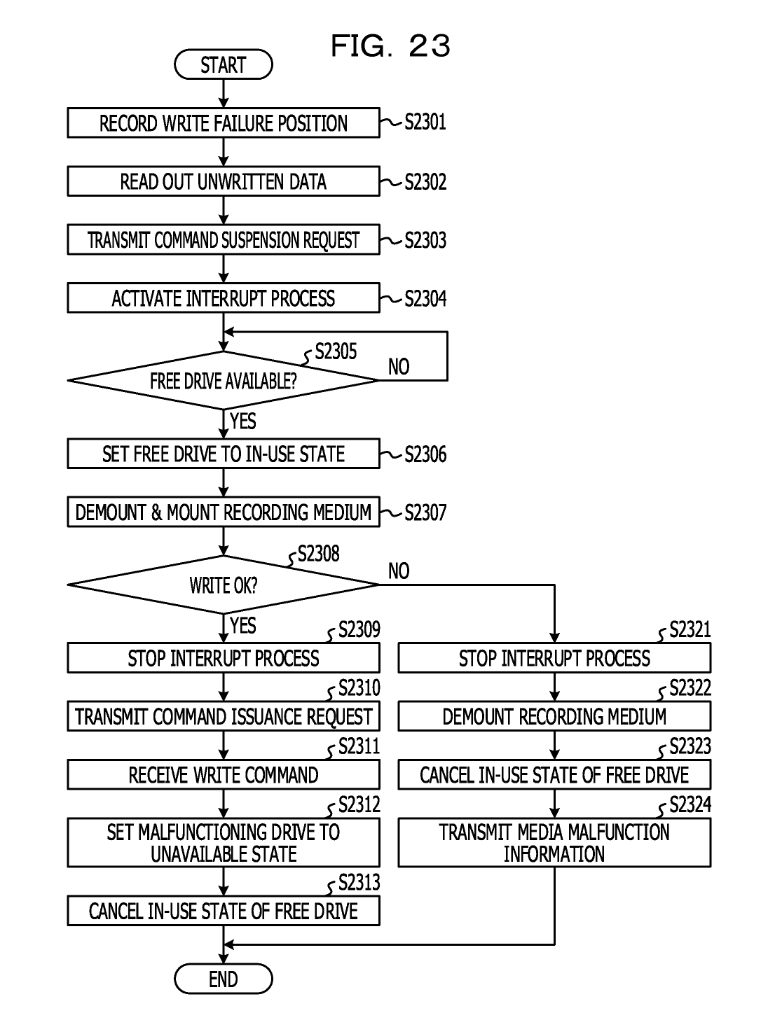

Next, the operation of the library device 1902 in FIG. 19 will be described in further detail with reference to FIGS. 23 to 27.

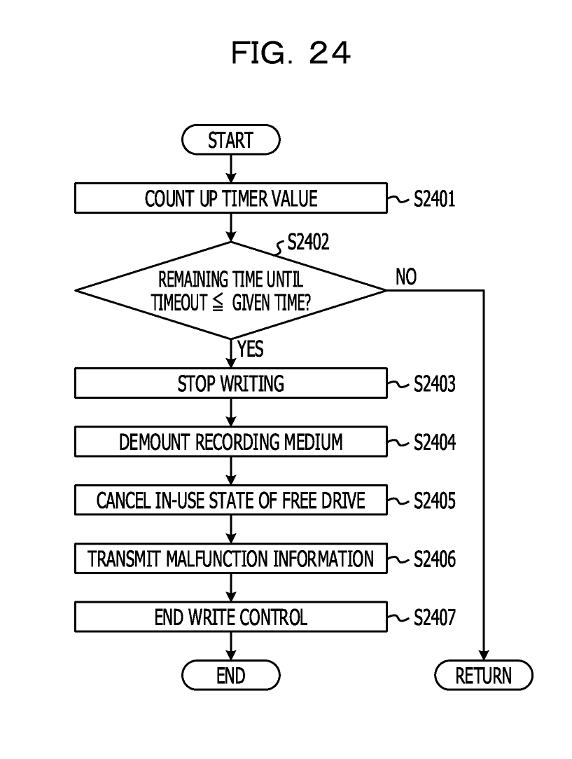

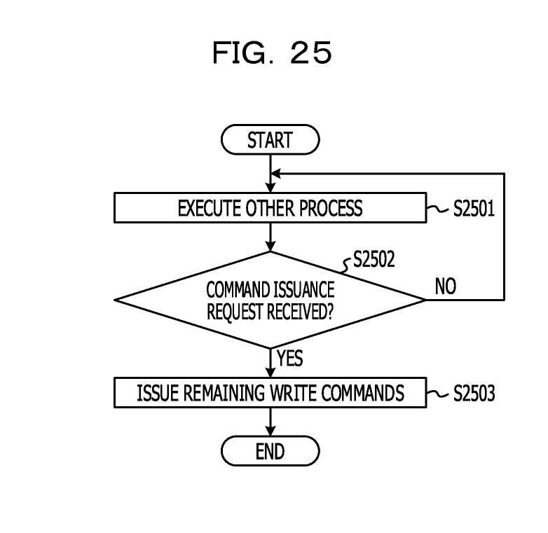

FIG. 23 is a flowchart illustrating an example of write control conducted by the controller 1921 in the case where a write error occurs during the asynchronous writing from the data buffer 1933-1 of the drive 1922-1 to the recording medium 2201. FIG. 24 is a flowchart illustrating an example of an interrupt process conducted by the controller 1921 as part of the write control in FIG. 23. FIG. 25 is a flowchart illustrating an example of a process conducted by the host device 1901.

In the case where a write error occurs during the asynchronous writing from the data buffer 1933-1 of the drive 1922-1 to the recording medium 2201, the drive 1922-1 transmits to the controller 1921 a response indicating that a write error has occurred.

Accordingly, the controller 1921 transmits to the drive 1922-1 a command RDBID for reading the position (the write failure position) of data that failed to be written to the recording medium 2201 (S2301 in FIG. 23). The drive 1922-1 transmits the write failure position to the controller 1921, and the controller 1921 records the received write failure position in the memory 2103. A block identifier (ID) of the data that failed to be written may be used as the write failure position, for example.

Next, the controller 1921 transmits to the drive 1922-1 a command RDBUF for reading unwritten data from the data buffer 1933-1 of the drive 1922-1 (S2302). The drive 1922-1 transmits to the controller 1921 the unwritten data, including the data that failed to be written, stored in the data buffer 1933-1 at and after the write failure position. The controller 1921 stores the received unwritten data in the data buffer 1925.

Next, the controller 1921 transmits to the host device 1901 a command suspension request which requests temporal suspension of issuance of commands from the host device 1901 (S2303).

The host device 1901, upon receiving the command suspension request from the controller 1921, temporarily pauses the backup process, and executes another process (S2501 in FIG. 25). Subsequently, the host device 1901 checks whether or not a command issuance request, which requests issuance of commands from the host device 1901, has been received from the controller 1921 (S2502), and in the case of not receiving a command issuance request (S2502, No), continues the other process.

Next, the controller 1921 activates the interrupt process in FIG. 24 (S2304), and checks whether or not a drive 1922 other than the drive 1922-1 is free (S2305). For example, in the case where a drive 1922 from among the drives 1922-2 to 1922-4 satisfies the following conditions, that drive 1922 is determined to be a free drive 1922.

(1) A recording medium is not mounted in the drive 1922.

(2) A given amount of time has elapsed since receiving the most recent command for a drive 1922 from the host device 1901. The given amount of time is preferably an amount of time equal to or greater than the time taken for the controller 1921 to execute control based on the received command.

In the absence of a free drive 1922 (S2305, No), the controller 1921 repeats the processing in S2305 until a free drive 1922 is found. In the presence of a free drive 1922 (S2305, Yes), the controller 1921 sets that free drive 1922 to an in-use state (S2306).

Hereinafter, the case where the drive 1922-2 is the free drive 1922 will be described. The controller 1921 is able to set the drive 1922-2 to an in-use state, for example, by setting an assign flag for the drive 1922-2 to ON. The assign flag may be stored in the memory 2103. By setting the drive 1922-2 to an in-use state, it becomes possible to reply with a response indicating that the drive 1922-2 is in use when the controller 1921 receives a command for the drive 1922-2 from the host device 1901.

Next, the controller 1921 controls the operating unit 1923 to demount the recording medium 2201 from the drive 1922-1, and to mount the recording medium 2201 in the drive 1922-2 (S2307). The controller 1921 then positions the write position of the drive 1922-2 to the write failure position of the recording medium 2201.

Next, the controller 1921 transfers unwritten data from the data buffer 1925 to the drive 1922-2, and writes the unwritten data to the data buffer 1933-2 of the drive 1922-2. The drive 1922-2 writes unwritten data to the recording medium 2201 by synchronous writing. The controller 1921 then checks whether or not the writing of the unwritten data finished normally (S2308).

In the case where the writing of the unwritten data finished normally (S2308, Yes), the controller 1921 stops the interrupt process in FIG. 24 (S2309), and transmits a command issuance request to the host device 1901 (S2310).

In the case of receiving a command issuance request from the controller 1921 (S2502, Yes), the host device 1901 pauses the other process and resumes the backup process. Subsequently, the host device 1901 transmits to the controller 1921 remaining write commands for the drive 1922-1 (S2503).

The controller 1921 changes the destination of the received write command from the drive 1922-1 to the drive 1922-2, and transfers the write command to the drive 1922-2 instead of the drive 1922-1 (S2311). Thus, data included in the write command is written to the data buffer 1933-2 of the drive 1922-2. The drive 1922-2 then asynchronously writes data stored in the data buffer 1933-2 to the recording medium 2201.

Next, the controller 1921 sets the drive 1922-1 at which a write error has occurred to an unavailable state (S2312). The controller 1921 is able to set the drive 1922-1 to an unavailable state, for example, by switching the drive 1922-1 to an offline state.

In the case of receiving a write command for the drive 1922-1 from the host device 1901 after setting the drive 1922-1 to an unavailable state, the controller 1921 replies to the host device 1901 with a response indicating that the drive 1922-1 is in an unavailable state. The drive 1922-1 set to an unavailable state is replaced with a functioning drive by a user or operator.

Next, the controller 1921 cancels the in-use state of the drive 1922-2 (S2313). The controller 1921 is able to cancel the in-use state of the drive 1922-2, for example, by setting an assign flag for the drive 1922-2 to OFF. By cancelling the in-use state of the drive 1922-2, use of the drive 1922-2 becomes possible in the case of receiving a command for the drive 1922-2 from the host device 1901.

On the other hand, in the case where a write error occurs while writing unwritten data (S2308, No), the controller 1921 stops the interrupt process in FIG. 24 (S2321). The controller 1921 then controls the operating unit 1923 to demount the recording medium 2201 from the drive 1922-2 (S2322).

Next, the controller 1921 cancels the in-use state of the drive 1922-2 (S2323), and transmits to the host device 1901 media malfunction information indicating that the recording medium 2201 has malfunctioned (S2324). Thus, the host device 1901 is able to recognize that the recording medium 2201, and not the drive 1922-1, is malfunctioning.

After activating the interrupt process in FIG. 24, the controller 1921 repeats the interrupt process in fixed cycles during the write control in FIG. 23. The controller 1921 first counts up a timer value (S2401), and compares the remaining time until timeout against a given amount of time (S2402).

The time from the activation of the interrupt process until timeout is determined, for example, on the basis of how long the host device 1901 is able to defer commands in response to a command suspension request. In addition, the given amount of time is preferably an amount of time equal to or greater than the time taken for the controller 1921 to demount the recording medium 2201 from the drive 1922-2.

In the case where the remaining time is longer than the given amount of time (S2402, No), the interrupt process ends briefly, and the write control in FIG. 23 continues until the start of the next interrupt process.

On the other hand, in the case where the remaining time is less than or equal to the given amount of time (S2402, No), the writing of unwritten data using the free drive 1922-2 is stopped (S2403). The controller 1921 then controls the operating unit 1923 to demount the recording medium 2201 from the drive 1922-2 (S2404).

Next, the controller 1921 cancels the in-use state of the drive 1922-2 (S2405), and transmits to the host device 1901 malfunction information indicating that the drive 1922-1 or the recording medium 2201 has malfunctioned (S2406). Thus, the host device 1901 is able to recognize that either or both of the drive 1922-1 and the recording medium 2201 are malfunctioning.

Subsequently, the controller 1921 forcibly ends the write control in FIG. 23 (S2407).

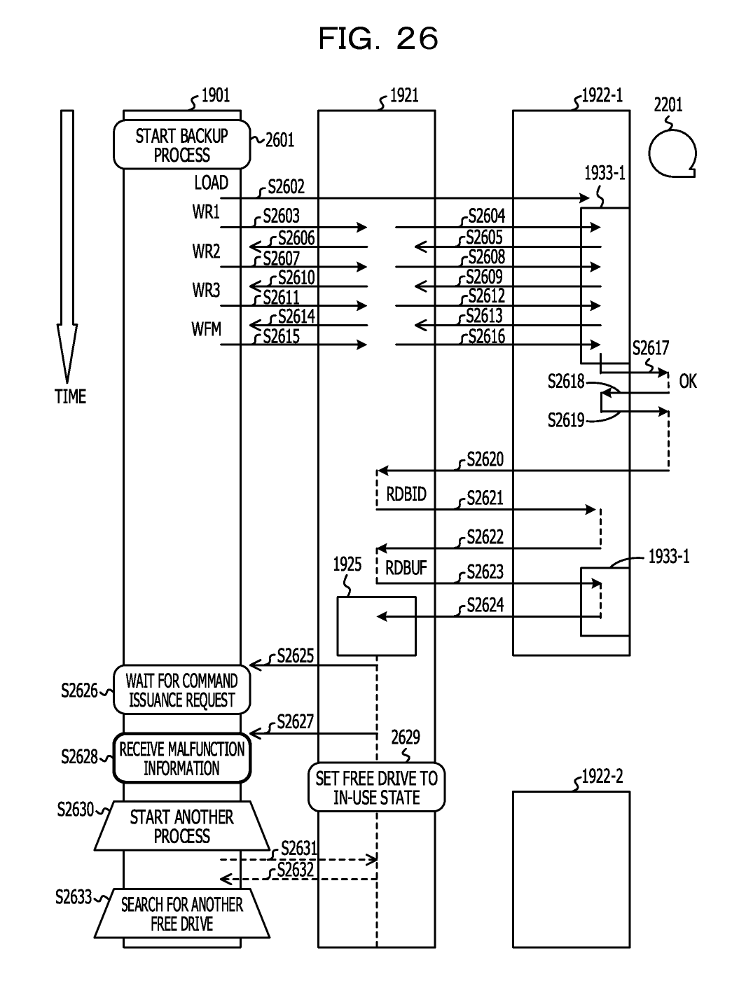

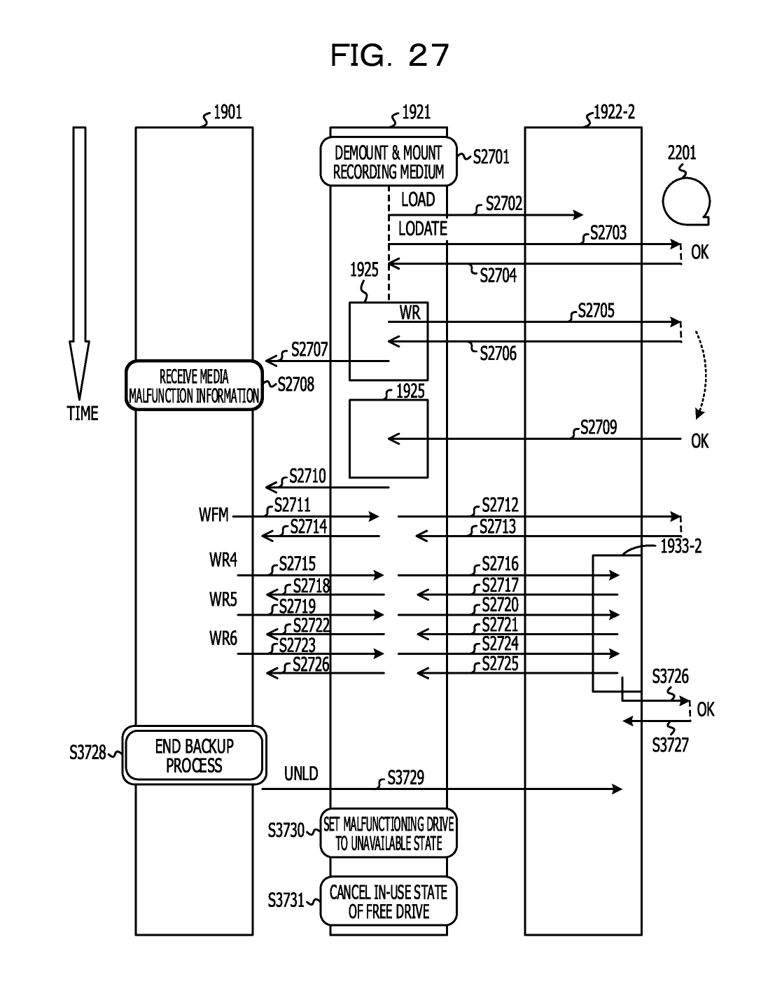

FIGS. 26 and 27 illustrate an example of a write control sequence in the case where a write error occurs during asynchronous writing by the drive 1922-1.

The host device 1901 starts a backup process specifying the drive 1922-1 (S2601 in FIG. 26). The host device 1901 then transmits a command LOAD for mounting the recording medium 2201 into the drive 1922-1 to the drive 1922-1 via the controller 1921 (S2602). At this point, the operating unit 1923, under control of the controller 1921, retrieves the recording medium 2201 from the storage 1924, and mounts the recording medium 2201 into the drive 1922-1.

Next, the host device 1901 transmits a write command WR1 to the controller 1921 (S2603). The controller 1921 writes data included in the write command WR1 to the data buffer 1933-1 by transferring the write command WR1 to the drive 1922-1 (S2604). The drive 1922-1 transmits to the controller 1921 a response indicating that the writing of the data has finished (S2605), and the controller 1921 transmits that response to the host device 1901 (S2606).

Next, the host device 1901 transmits a write command WR2 to the controller 1921 (S2607). The controller 1921 writes data included in the write command WR2 to the data buffer 1933-1 by transferring the write command WR2 to the drive 1922-1 (S2608). The drive 1922-1 transmits to the controller 1921 a response indicating that the writing of the data has finished (S2609), and the controller 1921 transmits that response to the host device 1901 (S2610).

Next, the host device 1901 transmits a write command WR3 to the controller 1921 (S2611). The controller 1921 writes data included in the write command WR3 to the data buffer 1933-1 by transferring the write command WR3 to the drive 1922-1 (S2612). The drive 1922-1 transmits to the controller 1921 a response indicating that the writing of the data has finished (S2613), and the controller 1921 transmits that response to the host device 1901 (S2614).

Next, the host device 1901 transmits a command WFM to the controller 1921 (S2615), and the controller 1921 transfers the command WFM to the drive 1922-1 (S2616). The drive 1922-1 defers execution of the command WFM.

At this point, the data buffer 1933-1 has become full, and consequently the drive 1922-1 writes the leading data stored in the data buffer 1933-1 to the recording medium 2201 (S2617). If the writing of the data finishes normally (S2618), the drive 1922-1 writes the next data stored in the data buffer 1933-1 to the recording medium 2201 (S2619). At this point, a write error occurs (S2620), and the drive 1922-1 transmits to the controller 1921 a response indicating that a write error has occurred.

Consequently, the controller 1921 transmits a command RDBID to the drive 1922-1 (S2621). The drive 1922-1 transmits the write failure position to the controller 1921 (S2622), and the controller 1921 records the received write failure position in the memory 2103.

Next, the controller 1921 transmits a command RDBUF to the drive 1922-1 (S2623). The drive 1922-1 transmits unwritten data stored in the data buffer 1933-1 to the controller 1921 (S2624). The controller 1921 stores the received unwritten data in the data buffer 1925.

Next, the controller 1921 transmits a command suspension request to the host device 1901 (S2625). The host device 1901 temporarily pauses the backup process, and waits to receive a command issuance request (S2626).

Next, the controller 1921 activates the interrupt process, and in the case where the remaining time until timeout is less than or equal to a given amount of time, transmits to the host device 1901 malfunction information indicating that the drive 1922-1 or the recording medium 2201 has malfunctioned (S2627). In the case of receiving malfunction information, the host device 1901 determines that either or both of the drive 1922-1 and the recording medium 2201 are malfunctioning, and ends the backup process (S2628).

In the case where the remaining time until timeout is greater than the given amount of time, the controller 1921 sets the free drive 1922-2 to an in-use state (S2629).

The host device 1901 starts another process (S2630), and transmits to the controller 1921 a command for the drive 1922-2 (S2631). Since the drive 1922-2 is set to an in-use state, the controller 1921 transmits to the host device 1901 a response indicating that the drive 1922-2 is currently in use (S2632). Accordingly, the host device 1901 searches for another free drive 1922 and continues the other process (S2633).

Next, the controller 1921 starts control to demount the recording medium 2201 from the drive 1922-1, and to mount the recording medium 2201 in the drive 1922-2 (S2701 in FIG. 27). The controller 1921 then transmits to the drive 1922-2 a command LOAD for mounting the recording medium 2201 into the drive 1922-2 (S2702). At this point, the operating unit 1923, under control of the controller 1921, demounts the recording medium 2201 from the drive 1922-1, and mounts the recording medium 2201 into the drive 1922-2.

Next, the controller 1921 transmits to the drive 1922-2 a command LOCATE for positioning the write position of the drive 1922-2 at the write failure position of the recording medium 2201 (S2703). The drive 1922-2 positions the write position at the write failure position of the recording medium 2201, and transmits to the controller 1921 a response indicating that the write position is positioned at the write failure position (S2704).

Next, the controller 1921 transfers unwritten data from the data buffer 1925 to the drive 1922-2, and the drive 1922-2 writes the unwritten data to the recording medium 2201 by synchronous writing (S2705).

In the case where a write error occurs during the writing of the unwritten data, the drive 1922-2 transmits to the controller 1921 a response indicating that a write error has occurred (S2706). The controller 1921 transmits to the host device 1901 media malfunction information indicating that the recording medium 2201 has malfunctioned (S2707). In the case of receiving media malfunction information, the host device 1901 determines that the recording medium 2201 is malfunctioning, and ends the backup process (S2708).

On the other hand, in the case where the writing of the unwritten data finishes normally, the drive 1922-2 transmits to the controller 1921 a response indicating that the writing of the unwritten data finished normally (S2709). The controller 1921 transmits a command issuance request to the host device 1901 (S2710).

The host device 1901 pauses the other process, resumes the backup process, and once again transmits a command WFM for the drive 1922-1 to the controller 1921 (S2711). The controller 1921 changes the destination of the received command WFM from the drive 1922-1 to the drive 1922-2, and transfers the command WFM to the drive 1922-2 (S2712).

The drive 1922-2 executes the command WFM, writes a tape mark on the recording medium 2201, and transmits to the controller 1921 a response indicating that the writing of the tape mark has finished normally (S2713). The controller 1921 transmits to the host device 1901 a response indicating that the writing of the tape mark has finished normally (S2714).

Next, the host device 1901 transmits to the controller 1921 the remaining write command WR4 for the drive 1922-1 (S2715). The controller 1921 changes the destination of the write command WR4 from the drive 1922-1 to the drive 1922-2, and transfers the write command WR4 to the drive 1922-2 (S2716). Thus, data included in the write command WR4 is written to the data buffer 1933-2. The drive 1922-2 transmits to the controller 1921 a response indicating that the writing of the data has finished (S2717), and the controller 1921 transmits that response to the host device 1901 (S2718).

Next, the host device 1901 transmits to the controller 1921 the remaining write command WR5 for the drive 1922-1 (S2719). The controller 1921 changes the destination of the write command WR5 from the drive 1922-1 to the drive 1922-2, and transfers the write command WR5 to the drive 1922-2 (S2720). Thus, data included in the write command WR5 is written to the data buffer 1933-2. The drive 1922-2 transmits to the controller 1921 a response indicating that the writing of the data has finished (S2721), and the controller 1921 transmits that response to the host device 1901 (S2722).

Next, the host device 1901 transmits to the controller 1921 the remaining write command WR6 for the drive 1922-1 (S2723). The controller 1921 changes the destination of the write command WR6 from the drive 1922-1 to the drive 1922-2, and transfers the write command WR6 to the drive 1922-2 (S2724). Thus, data included in the write command WR6 is written to the data buffer 1933-2. The drive 1922-2 transmits to the controller 1921 a response indicating that the writing of the data has finished (S2725), and the controller 1921 transmits that response to the host device 1901 (S2726).

The drive 1922-2 then asynchronously writes data stored in the data buffer 1933-2 to the recording medium 2201 (S3726), and detects that the data is written normally (S3727).

The host device 1901 ends the backup process (S3728), and transmits to the controller 1921 a command UNLD for demounting the recording medium 2201 from the drive 1922-1 (S3729). The controller 1921 changes the destination of the command UNLD from the drive 1922-1 to the drive 1922-2, and transfers the command UNLD to the drive 1922-2. At this point, the operating unit 1923, under control of the controller 1921, demounts the recording medium 2201 from the drive 1922-2, and stores the recording medium 2201 in the storage 1924.

The controller 1921 then sets the drive 1922-1 at which a write error occurred to an unavailable state (S3730), and cancels the in-use state of the drive 1922-2 (S3731).

The flowcharts in FIGS. 23 to 25 and the write control sequences in FIGS. 26 and 27 are merely examples, and some of the processing may be omitted or modified according to the configuration or other conditions of the host device 1901 or the library device 1902.

For example, S2303 and S2310 of FIG. 23 may be omitted in cases that allow the host device 1901 to keep issuing commands while unwritten data is being written to the recording medium 2201. In this case, S2625 of FIG. 26 and S2710 of FIG. 27 may also be omitted.

Also, S2324 of FIG. 23 and S2406 of FIG. 24 may be omitted in cases that allow malfunctions of the drive 1922-1 or the recording medium 2201 to not be reported to the host device 1901. In this case, S2627 of FIG. 26 and S2707 of FIG. 27 may also be omitted.

Furthermore, S2312 of FIG. 23 may be omitted in cases that allow continued usage of the drive 1922-1 at which a write error has occurred. In this case, S3730 of FIG. 27 may also be omitted.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention has been described in detail, it should be understood that the various changes, substitutions, and alterations could be made hereto without departing from the spirit and scope of the invention.

What is claimed is:

1. A library controller for controlling a library device including a first drive, a second drive, and an operating unit, the library controller comprising:
a data storage; and
a processor configured to
receive a plurality of data from a host device,
write the received plurality of data to a first data buffer included in the first drive,
instruct, upon occurrence of a first write error, the operating unit to demount a recording medium from the first drive and mount the recording medium into the second drive, the first write error being an error occurred while the first drive is writing partial data from among the plurality of data stored in the first data buffer to the recording medium,
receive unwritten data including the partial data from the first drive to store the received unwritten data in the data storage, the unwritten data being data stored in the first data buffer and not yet written to the recording medium, and
read the unwritten data stored in the data storage to write the read unwritten data to a second data buffer included in the second drive.

2. The library controller according to claim 1, wherein
the processor is further configured to
transmit a command suspension request to the host device upon occurrence of the first write error, the command suspension request being for requesting temporal suspension of issuance of commands from the host device, and
transmit a command issuance request to the host device when no error occurs while the second drive is writing the unwritten data stored in the second data buffer to the recording medium, the command issuance request being for requesting issuance of commands from the host device.

3. The library controller according to claim 2, wherein
the processor is further configured to
write, upon receiving a write command for the first drive from the host device after transmitting the command issuance request, data included in the received write command to the second data buffer.

4. The library controller according to claim 1, wherein
the processor is further configured to
set the first drive to an unavailable state when no error occurs while the second drive is writing the unwritten data stored in the second data buffer to the recording medium.

5. The library controller according to claim 1, wherein
the processor is further configured to
transmit media malfunction information to the host device when a second write error occurs while the second drive is writing the unwritten data stored in the second data buffer to the recording medium, the media malfunction information indicating that the recording medium has malfunctioned.

6. A computer-readable recording medium having stored therein a program for causing a computer to execute a process, the process comprising:
receiving a plurality of data from a host device;
writing the received plurality of data to a first data buffer included in a first drive;
instructing, upon occurrence of a first write error, an operating unit to demount a first recording medium from the first drive and mount the first recording medium into a second drive, the first write error being an error occurred while the first drive is writing partial data from among the plurality of data stored in the first data buffer to the first recording medium;
receiving unwritten data including the partial data from the first drive to store the received unwritten data in a data storage included in the computer, the unwritten data being data stored in the first data buffer and not yet written to the first recording medium; and
reading the unwritten data stored in the data storage to write the read unwritten data to a second data buffer included in the second drive.

7. A method for controlling a library device including a first drive, a second drive, and an operating unit, the method comprising:
receiving, by a computer, a plurality of data from a host device;
writing the received plurality of data to a first data buffer included in the first drive;
instructing, upon occurrence of a first write error, the operating unit to demount a recording medium from the first drive and mount the recording medium into the second drive, the first write error being an error occurred while the first drive is writing partial data from among the plurality of data stored in the first data buffer to the recording medium;
receiving unwritten data including the partial data from the first drive to store the received unwritten data in a data storage included in the computer, the unwritten data being data stored in the first data buffer and not yet written to the recording medium; and
reading the unwritten data stored in the data storage to write the read unwritten data to a second data buffer included in the second drive.
